(19) United States
(12) Patent Application Publication
(10) Pub. No.: US 2004/0169099 A1
(43) Pub. Date: Sep. 2, 2004

(54) Method for increasing the shearing resistance in disk chipper knife mounting clamps and a disk chipper equipped with such knife mounting clamps

(76) Inventor: Antti Tohkala, Pori (FI)

Correspondence Address: BURNS DOANE SWECKER & MATHIS L L P, POST OFFICE BOX 1404, ALEXANDRIA, VA, 22313-1404, US

(21) Appl. No.: 10/480,048

(22) PCT Filed: Jul. 1, 2002
(86) PCT No.: PCT/FI02/00587

(30) Foreign Application Priority Data
Jul. 4, 2001 (FI) 20011460

(51) Int. Cl. B02C 11/04

(52) U.S. Cl. 241/292.1

(57) ABSTRACT

The invention relates to a method for improving wear resistance and thoughness about the chip exit opening of the knife base (2′,14′,15) of a disc chipper knife (1′). According to the invenetion, the surface of the knife base bordering the chip exit opening is surface hardened over an edge area (18,18′,18″).

The present invention relates to a method for increasing the resistance in disk chipper knife mounting clamps against shearing wear and a disk chipper equipped with such mounting clamps.

Disc chippers are generally used in the wood processing industry for chipping wood prior to further processing. The rotary disc of the chipper has knives mounted thereon, evenly divided over the disc surface, for cutting chips from a log against a fixed counter knife. The chips exit through the disc via a disc exit opening located in front of the knife in its rotating direction. The knife is generally secured to the disc by means of separate clamp elements. The clamp elements are attached to the disc by screws and the knife stays secured between the clamp elements under compressive forces effected by the screws. One of the clamp elements mounted between the knife and the disc, generally known as the knife base or blade base, also serves to define one side of the chip exit opening that extends through the disc.

During chipping, the chips cut by the knife impinge in the vicinity of the chip exit opening on the knife base, wherefrom they bounce and continue their travel via the chip exit opening through the chipper disc. The side of the knife base receiving the impingement of the chips is subjected to heavy wear. The material of the knife base must be selected to be a medium-hard steel grade (hardness about 300 HB) and have a sufficiently ductile structure so that it will not crack into steel fragments under damaging conditions. However, this kind of material is not sufficiently resistant to the impact wear caused by the impinging wood chips.

A solution to the wear problem has been sought from an arrangement based on providing the tip of the knife base with a replaceable wear plate of a wear-resistant material. This kind of construction is disclosed, e.g., in patent publication U.S. Pat. No. 5,765,452.

As is taught in cited patent publication, the capability of the edge of the knife base to bear compressive stresses is reduced if the knife base is made from a material of relatively low yield strength. Therefore, it has been customary in the art to make the knife base into a single component as described in patent publication U.S. Pat. No. 5,765,452. The wear resistance of a single-component knife base has been improved by wear parts attached to the surface of the knife base delineating the chip exit opening. However, these arrangements have proven problematic. The requirement of weldability limits the maximum hardness of the material usable in the wear part, thus leading to compromises between easy securing and high wear resistance. Similar securing problems have also emerged in wear parts attached by other techniques.

In this context it must be noted that the problematic area or portion of the knife base is a very narrow zone bordering the tip edge of the knife base. The other portions of the knife base must nevertheless be of medium-tough steel having the earlier discussed qualities. In contrast, the crucial part of the knife base that receives the wear from the flow of chips or shavings must be very hard and rigidly secured to the body of the knife base. The local hardness of the wear part may even exceed that of the knife.

The goal of the invention is achieved by the features disclosed in the characterizing part of claim 1 in appended claims.

In the implementation of the invention, it is advantageous to make the body of the knife base from a steel grade having suitable qualities. The carbon content of the steel is preferably 0.3 to 0.5%. The steel is tempered and then annealed to 300 HB hardness. Then, the blank for the knife base has a sufficient yield strength and toughness, yet being readily to be machined. After machining, the crucial wear zone edge area is surface hardened, advantageously by induction hardening. The hardened area is an about 20 mm wide zone on the wear surface. The hardening depth is advantageously 2 to 3 mm. Then, the hardened portion of the knife base still retains a metallic bond with the massive body of the knife base. The surface hardness is made to be at least 50 HCR but may readily exceed 60 HRC. These hardness figures must be understood to represent only guideline numeric values, and good hardening properties may be attained even for low-carbon steel grades suitably alloyed. The toughness of the induction hardened edge portion can be improved by annealing, e.g., at a temperature of 200 to 250° C.

Next, the invention will be examined in greater detail by making reference to the attached drawings, wherein

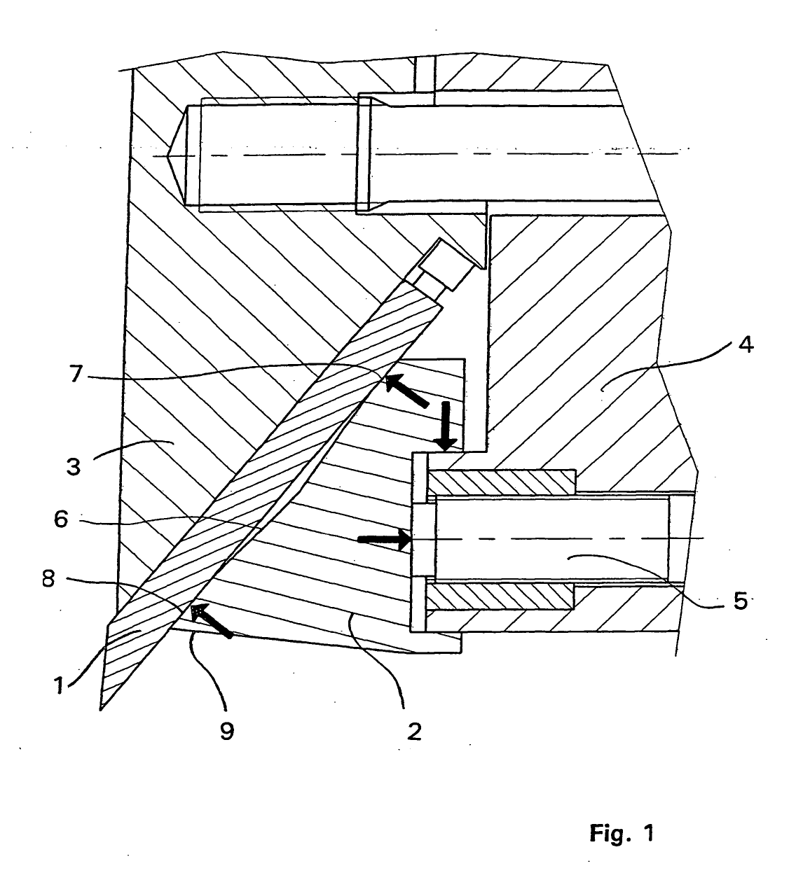

FIG. 1 shows a conventional knife holder assembly of a disc chipper and the knife base thereof;

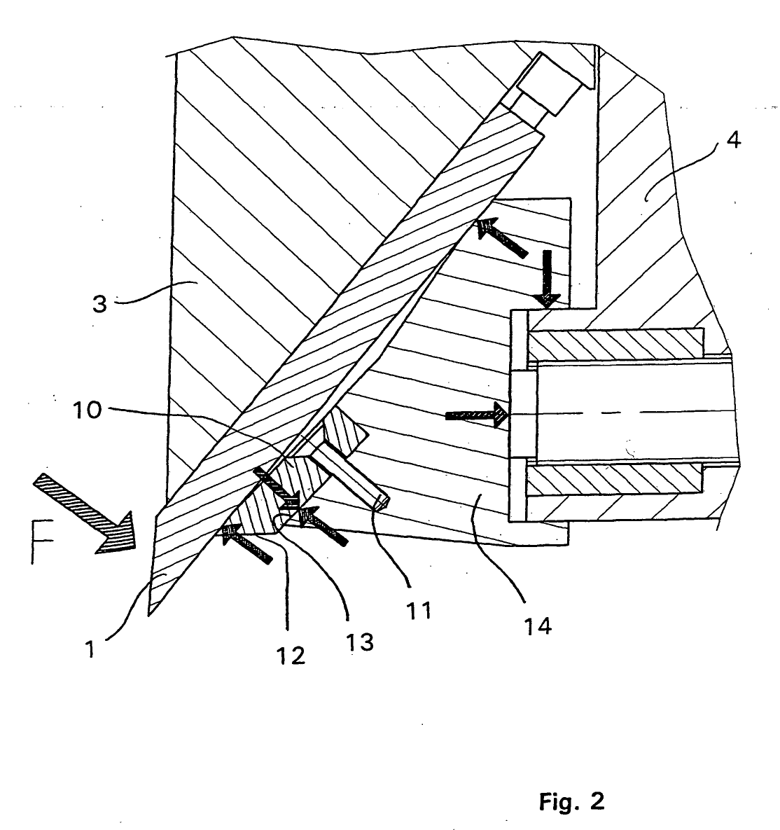

FIG. 2 shows a knife base together with the a knife abutment;

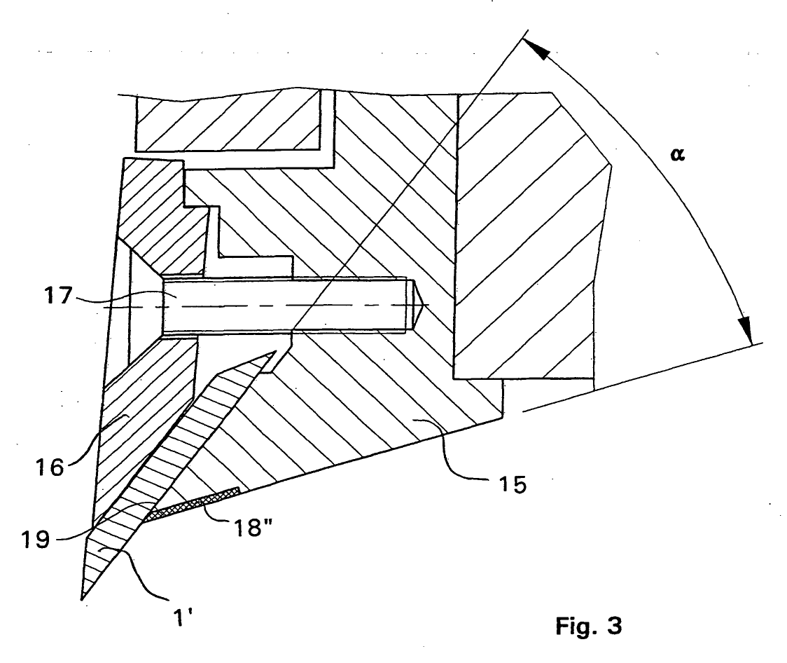

FIG. 3 shows a knife holder assembly of a modern disc chipper equipped with a reversible knife;

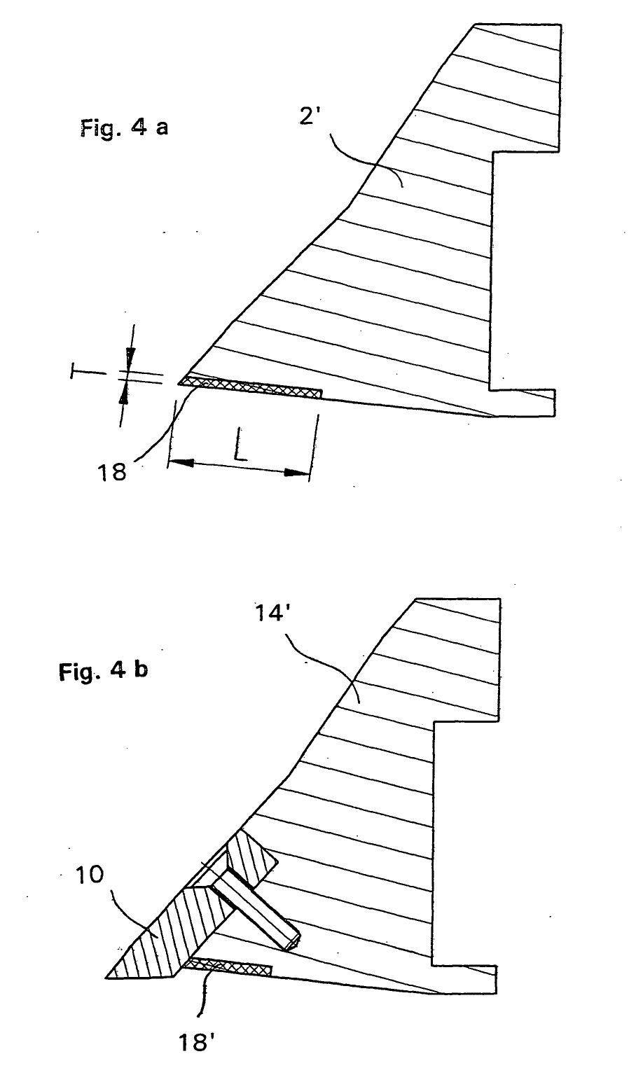

FIG. 4a shows a knife base according to the invention; and

FIG. 4b shows an alternative embodiment of the present knife base.

In FIG. 1 is shown a conventionally used knife holder assembly. The knife 1 is secured in place by clamping the knife by means of a knife base 2 against a wear plate 3. The knife base 2 is compressed against the knife 1 by means of a screw 5 backed against the chipper disc 4. The concave surface 6 of the knife base facing the knife 1 is machined such that the knife base backs the knife at points 7 and 8, whereby the backing force imposed on the knife 1 is optimal even when the mating parts may have been machined slightly inaccurately. Arrows drawn in FIGS. 1 and 2 denote the forces imposed from the knife base on the other parts of the chipper disc. In the diagrams, the concavity of surface 6 facing the knife base is exaggerated for greater clarity. The wear surface 9 eroded by the impinging chips on the knife base of FIG. 1 is reconditioned by hardfacing or, alternatively, the worn knife base is replaced by a new one. However, the hardfaced surface must be machined to dimensions, and, due to its limited hardness, hardfacing anyhow wears relatively rapidly thus necessitating frequent replacement of the knife base by a new or reconditioned spare part.

The knife base 14 shown in FIG. 2 is provided with a knife abutment 10 secured by screws 11 to the knife base. When sufficiently eroded at its surface 12 subjected to impinging chips, the worn knife abutment is replaced by a new one. This construction, however, is problematic in securing the knife abutment rigidly to the knife base, whereby complications generally occur in providing a sufficiently stiff support of the knife 1 to knife abutment 10 at surface 13 thereof. FIG. 2 also elucidates by arrows the forces imposed from the knife abutment to other parts of the chipper disc. During operation, surface 13 tends to undergo swaging under chipping forces acting on knife 1 as denoted by arrow F and further from the knife to knife abutment 10 and to knife base 14. If surface 13 yields, knife 1 can move, whereby wood pins and fines can enter the gap between the knife and the wear plate 3 and/or the knife abutment 10. As a result, the wear rate of the knife abutment is accelerated and the positioning of new knifes becomes complicated. In the knife clamp structure of FIG. 1, swaging takes place on surface 8 of the knife base assembly.

In FIG. 3 is shown a novel type of knife base assembly having the tip angle α of the knife base made smaller than 40°. The knife 1′ is secured to knife base 15 by a knife claw 16 and screws 17. Owing to the small tip angle α of the knife base, both the quality of chips is improved and the amount of pins and fines is reduced. However, the small tip angle makes it more complicated to design the knife base sufficiently stiff such that it supports the knife rigidly. Therefore, it is particularly important to construct the knife base in the knife holder assembly of FIG. 3 into a solid single part that gives sufficient support to the knife and simultaneously is resistant to deleterious swaging of surface 19.

FIGS. 3, 4a and 4b show a knife base according to the invention. First, a blank of the knife base is made from steel having a carbon content of about 0.3 to 0.5% that is then tempered and annealed to 300 HB hardness. The blank is machined into a knife base 2′ (FIG. 4a), and the wear surface subjected to erosion by impinging chips is treated by induction hardening 18.

In FIG. 4a, the induction-hardened area 18 has a width L of about 20 mm and a depth T of 2 to 3 mm. Induction hardening finishes the knife base 2′ into a solid single piece having a sufficient toughness and yet offering good wear resistance on the portion located at the edge of the chip exit opening in front of the knife. Herein, a metallic bond secures the hardened portion of the knife base to its massive body. A surface hardness in excess of 50 HRC (about 500 HB) is readily attainable. By the same token, also the local yield strength of the fixture parts increase by about 70%.

The material parameter figures quoted above represent only guideline numeric values, and, for instance, good hardenability may be attained even using low-carbon steel grades suitably alloyed. The toughness of the induction hardened edge portion can be improved by annealing, e.g., at a temperature of 200 to 250° C.

The induction hardened wear surface 18 makes the knife base 2′ more resistant to wear and improves its rigidity thus giving the knife better support under chipping forces. The swaging tendency of the knife base is eliminated by virtue of the invention. In the case that it anyhow is desired to use a smaller replaceable wear part such as knife abutment 10 shown in FIG. 4b, the induction hardening 18′ of knife base 14′ over the wear zone in front of knife abutment 10 yet gives improved support to the knife abutment 10. Also the wear resistance of knife base 14′ in front of the knife abutment is enhanced.

Induction hardening 18″ is also denoted in the reversible-knife knife holder assembly shown in FIG. 3, whereby it significantly serves to protect surface 19 against swaging and gives improved support to knife 1′.

What is claimed is:

1. A method for improving wear resistance and toughness about the chip exit opening of the knife base (2, 2′, 14, 14′, 15) of a disc chipper knife (1′), characterized in that an edge zone (18, 18′, 18″) of the knife base surface bordering the knife side opening (9) of the chip exit is surface hardened.

2. The method of claim 1, characterized in that the hardening step is carried out as induction hardening.

3. The method of claim 1 or 2, characterized in that the hardening step is carried out to hardening depth of about 2 to 3 mm.

4. The method of any one of foregoing claims 1-3, characterized in that the edge zone area of the knife base is hardened by a width of about 20 mm.

5. The method of any one of foregoing claims 14, characterized in that the surface hardening step is carried out to a hardness of at least 50 HRC.

6. The method of any one of foregoing claims 1-5, characterized in that the material of the knife base is selected to be steel with a carbon content of 0.3 to 0.5%, and that the knife base is tempered and annealed to a hardness of about 300 HB and then machined to its nominal dimensions prior to said surface hardening step.

7. A disc chipper, characterized by having its knife mounted on a knife base (2, 2′, 14, 14′, 15) having a surface hardened edge zone area (18, 18′, 18″).
